(19) United States
(12) Patent Application Publication
(10) Pub. No.: US 2010/0061119 A1
(43) Pub. Date: Mar. 11, 2010

(54) LIGHT GUIDE PLATE AND BACKLIGHT MODULE USING THE SAME

(75) Inventor: Yun-Tao GUO, Suzhou (CN)

Correspondence Address: BRIAN M. MCINNIS, 12th Floor, Ruttonjee House, 11 Duddell Street, Hong Kong, HK

(73) Assignees: AU OPTRONICS (SUZHOU) CORP., LTD., Suzhou (CN); AU OPTRONICS CORPORATION, Hsin-chu (TW)

(21) Appl. No.: 12/397,357

(22) Filed: Mar. 4, 2009

(30) Foreign Application Priority Data
Sep. 10, 2008 (CN) 200810212959.6

(51) Int. Cl. G02F 1/13357; G02B 5/02; F21V 13/12

(52) U.S. Cl. 362/625; 359/599

(57) ABSTRACT

A light guide plate for using in a backlight module is provided. The light guide plate has a top surface for emitting light, a back surface opposing to the top surface, and at least one light incident surface. The light incident surface in inclined by an angle β1 with respect to the back surface, wherein

$$90 ° - {sin}^{- 1} ( sin θ \times \frac{{n}_{a}}{{n}_{m}} ) \leq β 1 < 90 ° ,$$

and wherein θ is the incident angle of the light, nₐ is the refraction index of the incident medium, and nm is the refraction index of the light guide plate. In this way, when the light enters the light guide plate from the light incident surface, it would be guided toward the lower plane, and then the diffusion dots on the lower plane would diffusively reflect the light so that the light would exit from the top surface.

### RELATED APPLICATIONS

This application claims priority to China Application Serial Number 200810212959.6, filed Sep. 10, 2008, which is herein incorporated by reference.

### BACKGROUND

1. Field of Invention

The present invention relates to a light guide plate. More particularly, the present invention relates to a light guide plate for use in a backlight module.

2. Description of Related Art

A backlight illuminates liquid crystal displays (LCDs) from the side or back and can be used in small displays to increase readability in low light conditions and in computer displays and LCD televisions to produce light in a manner similar to a CRT display.

Common backlight module light sources include incandescent light bulbs, light-emitting diodes (LEDs), Electroluminescent panels (ELPs), cold cathode fluorescent lamps (CCFLs) or hot cathode fluorescent lamps (HCFLs) . . . etc. Presently, the most popular source of backlight module is CCFL. However, with the increasing demand for light and compact displays, the usage of LED backlights has been growing since the LED component is smaller than CCFL in size. For example, LED-backlit displays are employed in notebooks and netbooks fabricated by major manufacturers.

However, the LED is a point light source with high directivity and thus one challenge in the related field is to obtain good luminance uniformity.

### SUMMARY

In one aspect, the present invention is directed to a light guide plate for use in a backlight module. The light guide plate can distribute light radiated by the LED light source to provide uniform illumination and thus to improve the efficiency and quality of the display.

According to one embodiment of the present invention, the light guide plate comprises a top surface, a back surface, and at least one light incident surface. The top surface and back surface are opposite and substantially parallel to each other. An included angle β1 is formed between the light incident surface and the back surface, wherein

$$90 ° - {sin}^{- 1} ( sin θ \times \frac{{n}_{a}}{{n}_{m}} ) \leq β 1 < 90 ° ,$$

where θ is the incident angle of light, nₐ is the refractive index of the incident is medium, and nₘ is the refractive index of the light guide plate. Therefore, light entering the light guide plate from the light incident surface would be directed toward the back surface, and then at the back surface, a diffusion pattern consisting of a plurality of diffusion dots would diffusively reflect the light so as to allow the light exit from the top surface uniformly.

In another aspect, the present invention is related to a backlight module. According to one embodiment of the present invention, the backlight module comprises the light guide plate and at least one light source. The light source can be at least one LED disposed at the light incident surface. Therefore, the light radiated by the light source can enter the light guide plate from the light incident surface and be directed toward the back surface; at the back surface, a diffusion pattern consisting of a plurality of diffusion dots would diffusively reflect the light so as to allow the light exit from the top surface uniformly.

In yet another aspect, the present invention is related to a liquid crystal display comprising the backlight module according to the present invention.

It is to be understood that both the foregoing general description and the following detailed description are by examples, and are intended to provide further explanation of the invention as claimed.

### BRIEF DESCRIPTION OF THE DRAWINGS

To allow better understanding, embodiments of the present invention will be described in detailed by way of non-limitative example with reference to the accompanying drawings, in which:

FIG. 1 is a three dimensional view illustrating a backlight module is according to one embodiment of the present invention;

FIG. 2 is a schematic diagram illustrating the light guide plate of the backlight module of FIG. 1;

FIG. 3 is a cross-sectional diagram illustrating the backlight module of FIG. 1; and

FIG. 4 is a cross-sectional diagram illustrating a backlight module according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As stated above, light irradiated by the LED light source has high directivity, and thus the liquid crystal display using an LED backlight module would suffer from problems such as hot spots. LCD screen hot spots are caused by the non-homogenous distribution of the light irradiated by the LED. In order to alleviate this and other problems, diffusive means and/ or light guide plates are designed to direct light radiated by LED toward the panel of LCD.

Generally, the light guide plate is a specially-designed layer of plastic that diffuses light irradiated by the LED light source. In compact display devices, side-view white LED together with a light guide plate are often employed in the backlight module. In this case, at the light-emitting surface, light transmitting through the light guide plate would form bright bands in regions of constructive interference and dark bands in regions of destructive interference.

In view of the foregoing, in one aspect, the present invention is directed to a light guide plate for use in a backlight module. The light guide plate can uniformly direct the light toward the liquid crystal panel and thus reduce the occurrence of bright bands at the light-emitting surface. Therefore, the effectiveness and quality of the display device can be improved.

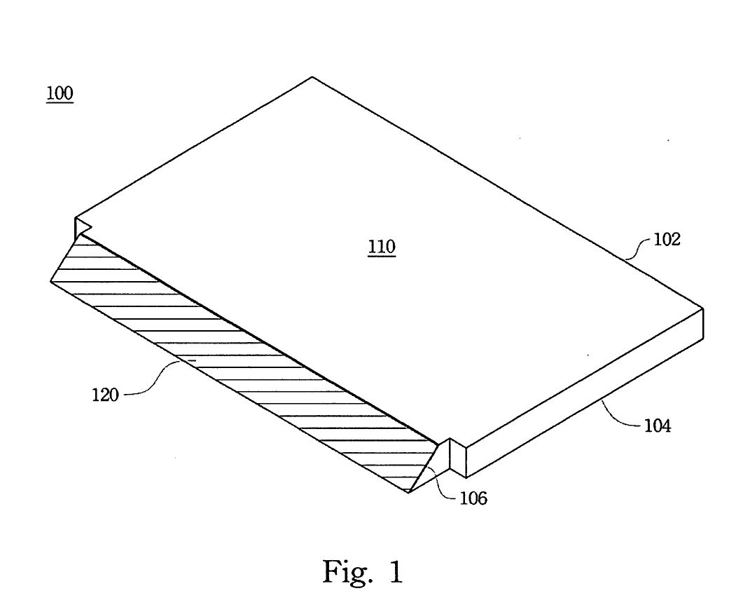

FIG. 1 is a three dimensional view illustrating a backlight module according to one embodiment of the present invention. In FIG. 1, a backlight module 100 comprises a light guide plate 110 and a light source 120. More specifically, the light guide plate 100 has a top surface 102, a back surface 104 opposite to and substantially parallel to the top surface 102, a diffusion pattern (not shown) located at the back surface 104, and a first light incident surface 106. The light source 120 can be an LED light source disposed at the first light incident surface 106. An included angle β1 is formed between the first light incident surface 106 and the back surface 104, and wherein

$$90 ° - {sin}^{- 1} ( sin θ \times \frac{{n}_{a}}{{n}_{m}} ) \leq β 1 < 90 ° ,$$

where θ is the incident angle of light, nₐ is the refractive index of the incident medium, and nₘ is the refractive index of the light guide plate 110.

In this way, when the light irradiated by the light source 120 enters the light guide plate 110 from the first light incident surface 106, the incident light is refracted toward the back surface 104. Then, at the back surface 104, the plurality of diffusion dots diffusively reflect the light toward the top surface 102 so as to allow the light exit from the light guide plate 110 via the top surface 102.

It should be noted that, in this embodiment, the included angle β1 between the first light incident surface 106 and the back surface 104 can alter the incident angle of the light entering the light guide plate 110 from the light source 120 and alter the transmitting path of the light across the light guide plate 110.

Altering the path of the light is advantageous in at least two ways. First, the light entering the light guide plate 110 can be directed toward the back surface 104 at where the light can be uniformized by a plurality of diffusion dots that form diffusion pattern on the back surface 104. In this way, the energy of the light can be distributed uniformly and thus the occurrence of hot spots at the first light incident surface 106 can be reduced. Second, under the arrangement according to the embodiment, the light that would otherwise exit the light guide plate 110 directly could also be made uniform and thus the occurrence of bright bands at the top surface 102 can be reduced.

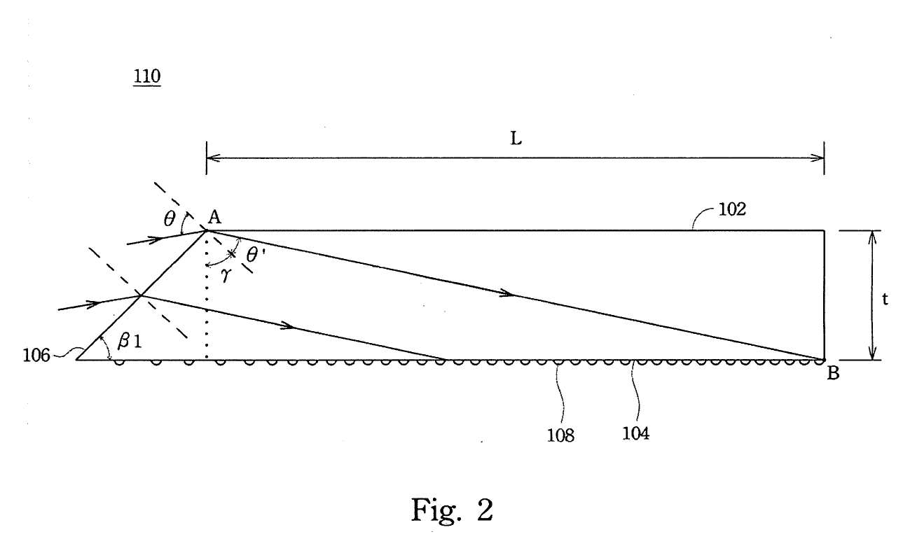

The following equations have been developed to determine the value of the included angle β1 and are described with referencing to FIG. 2. FIG. 2 is a schematic diagram illustrating the light guide plate 110 of the backlight module 100 of FIG. 1, where L is the length of the top surface 102 of the light guide plate 110, t is the distance between the top surface 102 and the back surface 104, β1 is the included angle between the light incident surface 106 and the back surface 104, θ is the incident angle of the light, and θ′ is the refracted angle of the light. In FIG. 2, the diffusion dots 108 forming the diffusion pattern is shown at the back surface 104, the path of the light is shown by arrows, and the normal line of the point of incidence is indicated by dash lines.

To achieve maximal light distribution effect, the light entering the light is guide plate 110 should cover the full extent of the and back surface 104 after being refracted, in other words, the light incident from point A should at least arrive at point B. Equation (1) takes this condition into account and is expressed as:

$$tan ( {θ}^{′} + γ ) \geq \frac{L}{t} \qquad Equation ( 1 )$$

According to the structure of the light guide plate, L is much greater than t and it is known that β1=γ, thus, equation (1) can be simplified into the equation (2) as follows:

β1≧90°−θ′ Equation (2)
θ′ is equation (2) can be expressed as the function of the refractive index of the incident medium (nₐ) and the refractive index of the light guide plate 110 (nₘ). Thus, θ′ can be expressed as the following equation (3):

$$sin {θ}^{′} = sin θ \times \frac{{n}_{a}}{{n}_{m}} \qquad Equation ( 3 )$$

Substituting equation (3) into equation (2) yields equation (4) as follows:

$$β 1 \geq 90 ° - {sin}^{- 1} ( sin θ \times \frac{{n}_{a}}{{n}_{m}} ) \qquad Equation ( 4 )$$

Furthermore, since the light path should be directed toward the back surface 104, β1 must be less than 90°, and hence the suitable value of the included angle β1 according to the embodiment can be expressed as the following equation (5):

$$90 ° - {sin}^{- 1} ( sin θ \times \frac{{n}_{a}}{{n}_{m}} ) \leq β 1 < 90 ° \qquad Equation ( 5 )$$

According to one embodiment of the present invention, the material of the light guide plate 110 can be polymethyl methacrylate (PMMA) having a refractive index of about 1.48. In addition, since the light source is in close proximity to the light incident surface 106 the refractive index of the incident medium (nₐ) is considered as 1. The light irradiated by LED light source has high directivity wherein most energy of the light is distributed within about ±55° from the optic axis of the LED light source and thus the maximum of θ is about 55°. Using these parameters in equation (5) reveals that 56.4°≦β1<90°.

According to another embodiment of the present invention, the material of the light guide plate 110 can be polycarbonate (PC) having a refractive index of about 1.59. Similarly, the refractive index of the incident medium (nₐ) is considered as 1 and the maximum of θ is about 55°. Using these parameters in equation (5) reveals that 60.5°≦1<90°.

According to these and other embodiments of the present invention, the suitable range of β1 can be calculated with respect to the light guide plate material used. In addition, by selecting a specific β1 value according to the suitable range and by arranging the size and density of the diffusion dots 108 on the back surface 104, it is possible to alter the optical effect of the LED backlight module 100.

For example, when choosing a greater β1 value, the light diffused by the diffusion dots that near the light incident surface 106 is less and thus the areas of hot spots are greater in relation to those light guide plate employing smaller β1 value.

As described above, in FIG. 2, the light guide plate 110 has a diffusion pattern consisting of a plurality of diffusion dots 108. When the light arrives at the diffusion dots 108 at the back surface 104, the diffusion dots 108 mat diffusively reflect the light to further alter the path of the light transmitted across the light guide plate 110 so that the light can be uniformized.

There are mainly two ways to form the diffusion dots including printing technique and chemical etching. In printing technique, materials having high light-scattering ability such as SiO₂ or TiO₂ can be screen printed at the back surface 104 of the light guide plate 110 so as to form diffusion pattern thereon. In chemical etching, diffusion dots are transfer printed onto a mold with light-sensitive ink, the ink is exposure developed and then etched.

With respect to the light guide plate of side-view backlight module, the diffusion dots 108 are arranged so that a distribution density of the diffusion dots 108 increases with increasing distance from the light source 120. Besides, sizes of the diffusion dots 108 increase with increasing distance from the light source 120. In this way, the light reflected by the diffusion dots can exit uniformly from the top surface 102.

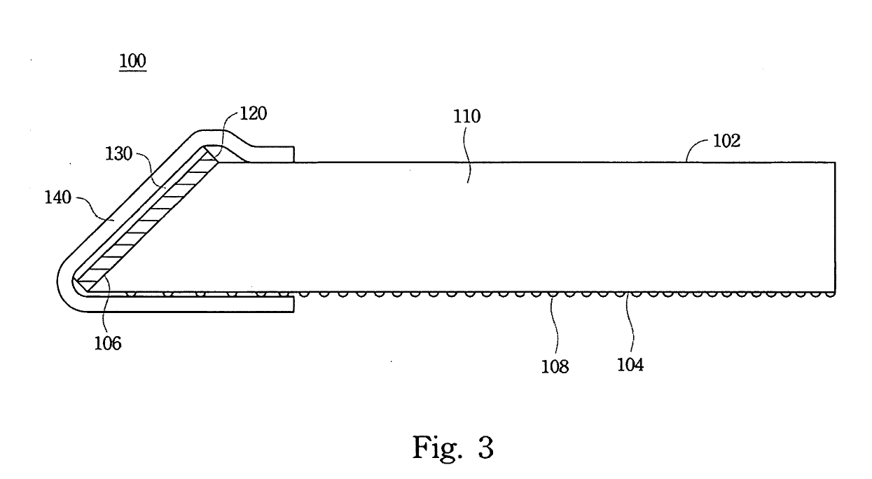

FIG. 3 is a cross-sectional diagram illustrating the backlight module 100 of FIG. 1. The backlight module 100 comprises a light guide plate 110, a light source 120, a flexible circuit board 130 and a housing 140. The back surface 104 of the light guide plate 110 has a plurality of diffusion dots 108 formed thereon. The light source 120 is located on the flexible circuit board 130, and the light source 120 is immediately next to the light incident surface 106. The housing 140 covers the entire light source 120 (including the flexible circuit board 130) and covers part of the top surface 102 and the back surface 104.

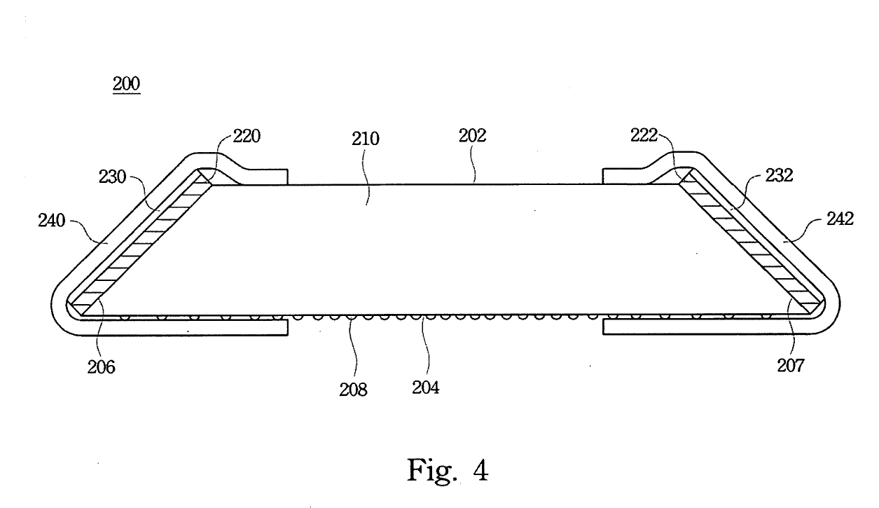

FIG. 4 is a cross-sectional diagram illustrating a backlight module according to another embodiment of the present invention. According to FIG. 4, the backlight module 200 is a double-side emitting LED backlight module, and the structure thereof is similar to that of the backlight module 100 of FIG. 3.

More specifically, the backlight module 200 comprises a light guide plate 210, a first light source 220, a second light source 222, a first flexible circuit board 230, a second flexible circuit board 232, a first housing 240, and a second housing 242. The back surface 204 of the light guide plate 210 has a plurality of diffusion dots 208 formed thereon. The first light source 220 and the second light source 222 are located on the first flexible circuit board 230 and the second flexible circuit board 232, respectively. The first light source 220 and the second light source 222 are immediately next to the first light incident surface 206 and the second light incident surface 207, respectively. The second light incident surface 207 is opposite to the first light incident surface 206. The first housing 240 and the second housing 242 cover the entire first light source 220 (including the flexible circuit board 230)and the entire second light source 222 (including the flexible circuit board 232), respectively, and both cover part of the top surface 202 and the back surface 204. According to Equation (1)-(2)-(3)-(4) and (5), the angle β2 between the second light incident surface 207 and the back surface 104 could be express as

$$90 ° - {sin}^{- 1} ( sin θ \times \frac{{n}_{a}}{{m}_{m}} ) \leq β 2 < 90 ° \qquad Equation ( 6 )$$

so that light incident from the second light incident surface 207 is refracted toward the back surface 104, and then at the back surface 104, the plurality of diffusion dots diffusively reflect the light toward the top surface 202 so as to allow the light exit from the light guide plate via the top surface 202.

According to one embodiment of the present invention, the material of the light guide plate 210 can be polymethyl methacrylate (PMMA) having a refractive index of about 1.48. In addition, since the light source is in close proximity to the light incident surface 206 the refractive index of the incident medium (nₐ) is considered as 1. The light irradiated by LED light source has high directivity wherein most energy of the light is distributed within about ±55° from the optic axis of the LED light source and thus the maximum of θ is about 55°. Using these parameters in equation (6) reveals that 56.4°≦β2<90°.

According to another embodiment of the present invention, the material of the light guide plate 210 can be polycarbonate (PC) having a refractive index of about 1.59. Similarly, the refractive index of the incident medium (nₐ) is considered as 1 and the maximum of θ is about 55°. Using these parameters in equation (6) reveals that 60.5°β2<90°.

According to another embodiment of the present invention, the diffusion dots 208 are arranged so that a distribution density of the diffusion dots 208 increases with increasing distance from the first light source 220 and the second light source 222. Besides, the sizes of the diffusion dots 208 increase with increasing distance from the first light source 220 and the second light source 222. In this way, the light reflected by the diffusion dots 208 can exit uniformly from the top surface 202.

The backlight modules according to the examples of the present invention can be used in liquid crystal display. Due to the structure of the backlight module the occurrence of hot spots and bright bands can be effectively reduced. In application, the backlight modules provides uniformly distributed light for irradiating the liquid crystal panel whereby significantly improves the effectiveness and quality of the display device.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A light guide plate for use in a backlight module, the light guide plate comprising:
a top surface;
a back surface opposite to the top surface;
a diffusion pattern disposed at the back surface, wherein the diffusion pattern consists of a plurality of diffusion dots; and
a first light incident surface, wherein an included angle β1 is formed between the first light incident surface and the back surface, and wherein
$$90 ° - {sin}^{- 1} ( sin θ \times \frac{{n}_{a}}{{n}_{m}} ) \leq β 1 < 90 °$$
so that light incident from the first light incident surface is refracted toward the back surface, and then at the back surface, the plurality of diffusion dots diffusively reflect the light toward the top surface so as to allow the light to exit from the light guide plate via the top surface, where θ is the incident angle of light, nₐ is the refractive index of the incident medium, and nₘ is the refractive index of the light guide plate.

2. The light guide plate of claim 1, further comprising a second light incident surface opposite to the first light incident surface, wherein an included angle β2 is formed between the second light incident surface and the back surface, and wherein
$$90 ° - {sin}^{- 1} ( sin θ \times \frac{{n}_{a}}{{n}_{m}} ) \leq β 2 < 90 °$$
so that light incident from the second light incident surface is refracted toward the back surface, and then at the back surface, the plurality of diffusion dots diffusively reflect the light toward the top surface so as to allow the light exit from the light guide plate via the top surface.

3. The light guide plate of claim 1, wherein the top surface substantially parallel to the back surface.

4. The light guide plate of claim 1, wherein the material of the light guide plate is polymethyl methacrylate or polycarbonate.

5. The light guide plate of claim 1, wherein when the refractive index of the light guide plate is about 1.48, β1 is no less than 56.4° and less than 90°.

6. The light guide plate of claim 2, wherein when the refractive index of the light guide plate is about 1.48, β2 is no less than 56.4° and less than 90°.

7. The light guide plate of claim 1, wherein when the refractive index of the light guide plate is about 1.59, β1 is no less than 60.5° and less than 90°.

8. The light guide plate of claim 2, wherein when the refractive index of the light guide plate is about 1.59, β2 is no less than 60.5° and less than 90°.

9. The light guide plate of claim 1, wherein the diffusion dots are arranged so that a distribution density of the diffusion dots increases with increasing distance from a light source, and sizes of the diffusion dots increase with increasing distance from a light source.

10. A backlight module, comprising
a light guide plate, comprising
a top surface;
a back surface opposite to the top surface;
a diffusion pattern disposed at the back surface, wherein the diffusion pattern consists of a plurality of diffusion dots; and
a first light incident surface, wherein an included angle β1 is formed between the first light incident surface and the back surface, and wherein
$$90 ° - {sin}^{- 1} ( sin θ \times \frac{{n}_{a}}{{n}_{m}} ) \leq β 1 < 90 ° ,$$
where θ is the incident angle of light, nₐ is the refractive index of the incident medium, and nₘ is the refractive index of the light guide plate; and
a first light source, disposed at the first light incident surface, wherein the first light source comprises at least one light-emitting diode, wherein a first light irradiated by the first light source incidents from the first light incident surface and enters the light guide plate and is refracted toward the back surface where the plurality of diffusion dots diffusively reflect the light toward the top surface so as to allow the light exit from the light guide plate via the top surface.

11. The backlight module of claim 10, further comprising:
a second light incident surface opposite to the first light incident surface, wherein an included angle β2 is formed between the second light incident surface and the back surface, and wherein
$$90 ° - {sin}^{- 1} ( sin θ \times \frac{{n}_{a}}{{n}_{m}} ) \leq β 2 < 90 ° ;$$
and
a second light source, disposed at the second light incident surface, wherein the second light source comprises at least one light-emitting diode, wherein a second light irradiated by the second light source incidents from the second light incident surface and enters the light guide plate and is refracted toward the back surface where the plurality of diffusion dots diffusively reflect the light toward the top surface so as to allow the light exit from the light guide plate via the top surface.

12. The backlight module of claim 10, wherein the top surface substantially parallel to the back surface.

13. The backlight module of claim 10, wherein the material of the light guide plate is polymethyl methacrylate or polycarbonate.

14. The backlight module of claim 10, wherein the light-emitting diode is disposed at a flexible circuit board.

15. The backlight module of claim 11, wherein the light-emitting diode is disposed at a flexible circuit board.

16. The backlight module of claim 10, wherein when the refractive index of the light guide plate is about 1.48, β1 is no less than 56.4° and less than 90°.

17. The backlight module of claim 11, wherein when the refractive index of the light guide plate is about 1.48, β2 is no less than 56.4° and less than 90°.

18. The backlight module of claim 10, wherein when the refractive index of the light guide plate is about 1.59, β1 is no less than 60.5° and less than 90°.

19. The backlight module of claim 11, wherein when the refractive index of the light guide plate is about 1.59, β2 is no less than 60.5° and less than 90°.

20. The backlight module of claim 10, wherein the diffusion dots are arranged so that a distribution density of the diffusion dots increases with increasing distance from a light source, and sizes of the diffusion dots increase with increasing distance from a light source.

21. A liquid crystal display, comprising a backlight module comprising a light guide plate, comprising:
a top surface;
a back surface opposite to the top surface;
a diffusion pattern disposed at the back surface, wherein the diffusion pattern consists of a plurality of diffusion dots; and
a first light incident surface, wherein an included angle β1 is formed between the first light incident surface and the back surface, and wherein
$$90 ° - {sin}^{- 1} ( sin θ \times \frac{{n}_{a}}{{n}_{m}} ) \leq β 1 < 90 ° ,$$
where θ is the incident angle of light, na is the refractive index of the incident medium, and nm is the refractive index of the light guide plate; and
a first light source, disposed at the first light incident surface, wherein the first light source comprises at least one light-emitting diode, wherein a first light irradiated by the first light source incidents from the first light incident surface and enters the light guide plate and is refracted toward the back surface where the plurality of diffusion dots diffusively reflect the light toward the top surface so as to allow the light exit from the light guide plate via the top surface.

22. The liquid crystal display of claim 21, wherein the backlight module further comprising:
a second light incident surface opposite to the first light incident surface, wherein an included angle β2 is formed between the second light incident surface and the back surface, and wherein
$$90 ° - {sin}^{- 1} ( sin θ \times \frac{{n}_{a}}{{n}_{m}} ) \leq β 2 < 90 ° ;$$
and
a second light source, disposed at the second light incident surface, wherein the second light source comprises at least one light-emitting diode, wherein a second light irradiated by the second light source incidents from the second light incident surface and enters the light guide plate and is refracted toward the back surface where the plurality of diffusion dots diffusively reflect the light toward the top surface so as to allow the light exit from the light guide plate via the top surface.
